(19) United States
(12) Patent Application Publication
(10) Pub. No.: US 2016/0036498 A1
(43) Pub. Date: Feb. 4, 2016

(54) Method of Wireless Power Connection

(71) Applicant: HTC Corporation, Taoyuan City (TW)

(72) Inventor: Feng-Seng Chu, Taoyuan City (TW)

(21) Appl. No.: 14/811,854

(22) Filed: Jul. 29, 2015

Related U.S. Application Data
(60) Provisional application No. 62/031,877, filed on Aug. 1, 2014.

(51) Int. Cl. H04B 5/00; H04W 4/00; H04W 52/02

(52) U.S. Cl. CPC H04B 5/0037; H04W 52/0238; H04W 4/008

(57) ABSTRACT

A method of a wireless power connection for a power transmitting unit in a wireless power system is disclosed. The method comprises providing a wireless power to a first power receiving unit (PRU) of a wireless power system, communicating with the first PRU via a first communication interface and a second communication interface; detecting the appearance of a second PRU, and transmitting a first message through the second communication interface to the first PRU, wherein the first message is used for requiring that the first PRU does not generate any interference on the first communication interface.

### CROSS REFERENCE TO RELATED APPLICATIONS

This application claims the benefit of U.S. Provisional Application No. 62/031,877, filed on Aug. 1, 2014 and entitled “Method and Apparatus to solve later Power Receive Unit (PRU) cross-connection problem”, the contents of which are incorporated herein in their entirety.

### BACKGROUND OF THE INVENTION

1. Field of the Invention

The present invention relates to a method used in a wireless power system, and more particularly, to a method of wireless power connection in a wireless power system.

2. Description of the Prior Art

Alliance for wireless power (A4WP) is a leading organization defining the resonant wireless power transfer (WPT) industrial standard, in which the wireless power can be delivered from Power Transmit Unit (PTU) to Power Receive Unit (PRU) in the distance without physical connection. Compared to other competing standardization committee, one major characteristic is to use the Bluetooth Low Energy (BLE) as communication interface between PTU and PRU. In addition, the Bluetooth Low Energy (BLE) link in the A4WP is intended for control of power levels, identification of valid loads and protection of non-compliant devices.

Please refer to FIG. 1, which illustrates a wireless charging operation between a PTU and a PRU. At first, when the PTU is powered up, it starts from the “Configuration” state to set up all the internal parameters properly. After that, it goes to the “Power Save” state and starts to send power beacon. The beacon is used to detect the appearance of the PRU and to provide initial power to BLE module in the PRU. When the PRU comes closed to the PTU, the PRU will be powered up by the power beacon and goes to “Boot” state from “Null” state. After getting into the “Boot” state, the PRU starts to send the initial message (advertisement defined in BLE) to the PTU. When the PTU receive this initial message, it leaves the “Power Save” state and goes to the “Low Power” state. In the beginning of the “Low Power” state, the PTU sends a connection request message to the PRU to initiates a negotiation process to exchange necessary information. After the necessary information is exchanged, the PTU makes decision on whether to supply wireless power to the PRU. If the decision is positive, the PTU leaves “Low Power” state, goes to the “Power Transfer” state and send a control message to the PRU to notify this decision. When the PRU receives this control message, it leaves the “Boot” state and goes to “On” state to periodically update its dynamic parameters to the PTU. In addition, the PTU goes to the “Latch Fault” state when there is something wrong, it may be due to an over-temperature report or an over-voltage report from the PRU, or an internal error inside the PTU.

Please refer to FIG. 2, which illustrates a cross connection in a wireless power system 20. The wireless power system 20 includes two PTUs PTU_A and PTU_B and three PRUs PRU_1, PRU_2 and PRU_3. The PTU_A is supplying wireless power to the PRU_1 while the PTU_B is supplying wireless power to the PRU_2 and PRU_3. Due to a BLE communication interface independent from the wireless power communication interface, a cross-connection problem may happen. In FIG. 2, there exists a BLE connection between PTU_A and PRU_1 to allow the PTU_A can get feedback information, such as the amount of power received, from PRU_1. There is also a BLE connection between PTU_B and PRU_3. However, the PRU_2 is not connecting to the PTU_B for some reasons but connects to PTU_A. So, the PTU_B cannot get correct information from the PRU_2. In other words, the PRU_2 connects to the PTU_A which is not supplying wireless power to the PRU_2. It is indeed a mismatch and both the PTUs (i.e. PTU_A and PTU_B) cannot get correct feedback information from the PRUs (i.e. PRU_1, PRU_2 and PRU_3) to which they are supplying power. Consequently, the PTU_A and PTU_B may provide wrong, e.g. excess or deficient, charging power to the PRU_1, PRU_2 and PRU_3.

### SUMMARY OF THE INVENTION

It is therefore an objective to provide a method of wireless power connection to solve the above problem.

The present invention discloses a method of a wireless power connection for a power transmitting unit in a wireless power system is disclosed. The method comprises providing a wireless power to a first power receiving unit (PRU) of a wireless power system, communicating with the first PRU via a first communication interface and a second communication interface; detecting the appearance of a second PRU, and transmitting a first message through the second communication interface to the first PRU, wherein the first message is used for requiring that the first PRU does not generate any interference on the first communication interface.

The present invention discloses a method of a wireless power connection for a power receiving unit (PRU) in a wireless power system. The method comprises receiving a wireless power from a power transmitting unit (PTU) of a wireless power system, communicating with the PTU via a first communication interface and a second communication interface, and receiving a first message through the second communication interface from the PTU, wherein the first message is used for requiring that the PRU does not generate any interference on the first communication interface.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless charging operation.

FIG. 2 is a schematic diagram of a cross connection.

FIG. 3 is a flowchart of a process according to an embodiment of the present invention.

FIG. 4 is a schematic diagram of a message flow in a wireless power connection according to an embodiment of the present invention.

### DETAILED DESCRIPTION

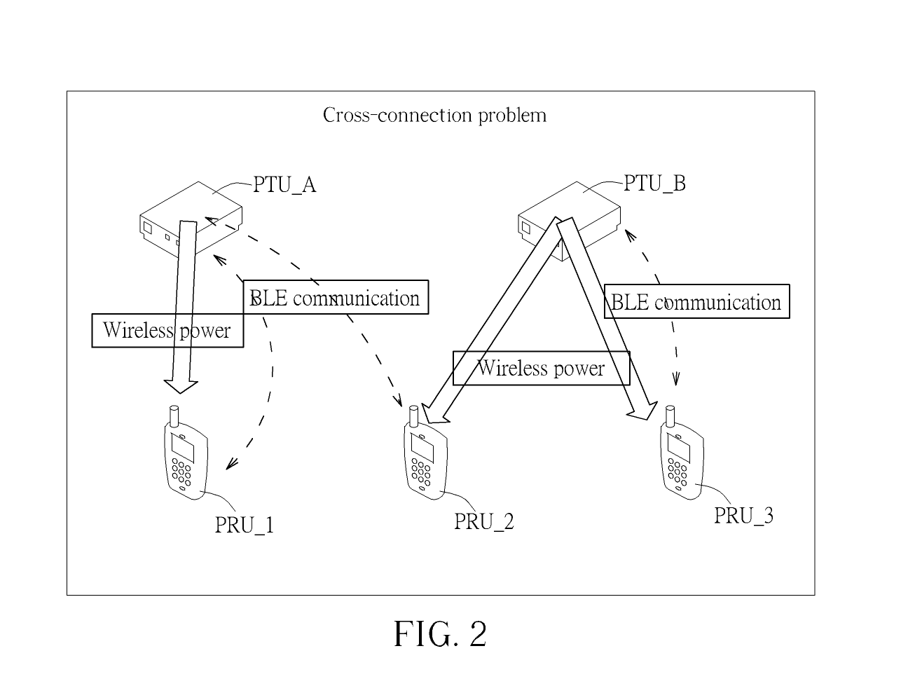

Please refer back to FIG. 2. The wireless power system 20 includes at least a PTU and a plurality of PRUs. However, the number is not limited herein. The PTU can be a wireless power transmission module consisting of coil, analog circuit (e.g. matching) and control IC. The PTU can also be a device which includes the wireless power transmission module. In this case, the PTU may include other modules such as BLE module or LCD module. For example, the PTU is a wireless charging pad. On the other hand, the PRU can be a wireless power reception module consisting of a coil, analog circuit (e.g. rectifier) and control IC. The PRU can also be a device which includes the wireless power reception module. In this case, the PRU may include other modules such as BLE module, LCD module or WIFI module. For example, the PRU is a smartphone.

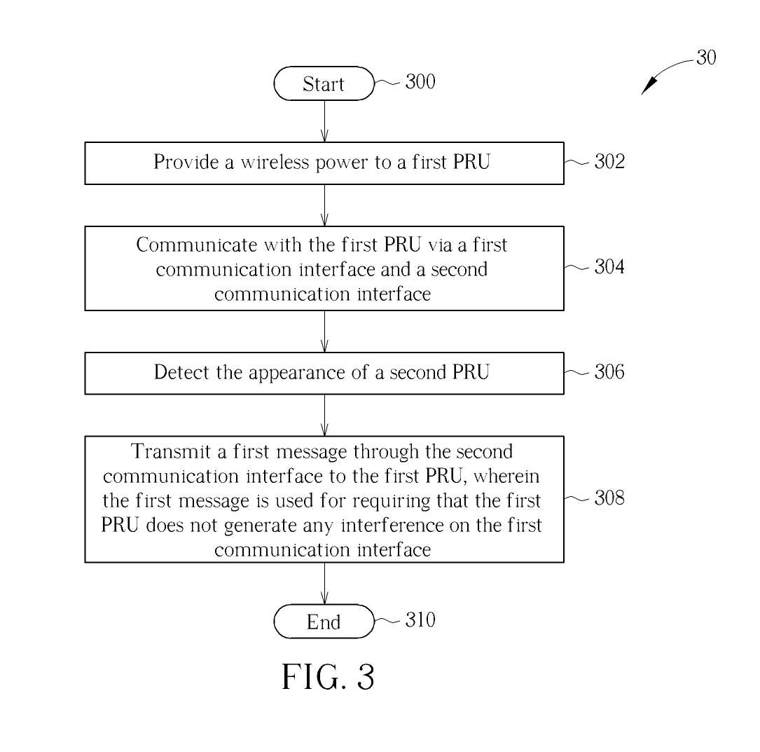

Please refer to FIG. 3, which is a flowchart of a process 30 according to an embodiment of the present invention. The process 30 is utilized in a PTU (i.e. PTU_A) of FIG. 2, to realize wireless power connection in the wireless power system 20. The process 30 includes the following steps:

Step 300: Start.

Step 302: Provide a wireless power to a first PRU.

Step 304: Communicate with the first PRU via a first communication interface and a second communication interface.

Step 306: Detect the appearance of a second PRU.

Step 308: Transmit a first message through the second communication interface to the first PRU, wherein the first message is used for requiring that the first PRU does not generate any interference on the first communication interface.

Step 310: End.

According to the process 30, the first PRU (i.e. PRU_1 of FIG. 2) is charged by the PTU, and connected to the PTU via two types of communication interfaces. The first type communication interface is attached on the wireless power signal and the second type communication interface is independent from the wireless power signal. When the PTU detects the appearance of the second PRU (i.e. PRU_2 of FIG. 2), the PTU sends the first message through the second type communication interface to the first PRU. The purpose of the first message is to require the first PRU not to generate interference on the first type communication interface. With such manner, signal transmission from the second PRU over the first communication interface can be detected by the PTU without interference. As a result, the second PRU sends a second message including an identity of the second PRU to the PTU through the first type communication interface, so that the PTU can connect with the second PRU through the first type communication interface correctly with the identity received from the second PRU.

Note that, the first message requiring the first PRU not to generate interference on the first type communication interface may indicate that the first PRU shall not adjust its load condition for a certain period. In addition, the first message may indicate a starting time or a period to the PTU, so that the first PRU knows it shall not adjust its load condition during the indicated duration.

There are some examples that the first PRU may want to change the load condition. One reason for the first PRU to change its load is to communicate with the PTU through the first communication interface (e.g. load modulation). In this case the transmissions would be postponed or cancelled. One possible reason for the first PRU to change its load is for internal operation, which might be requested by the controller (e.g. CPU) of the first PRU. In this case, the wireless power reception module may negotiate with the controller to postpone or cancel the change, or compensate the load change by itself. One possible reason for the first PRU to change its load is for proper power transfer operation, which is managed by the wireless power reception module itself. In this case, the module can determine to postpone or cancel the change.

The first type communication interface is attached on the wireless power signal. It is called as in-band communication in wireless power transfer system. Two examples here include the Load Modulation defined in WPC LPWG and MPWG specification. The second type communication interface is independent from the wireless power signal. It is usually called as out-of-band communication in wireless power transfer system. Some examples here include Bluetooth Low Energy (BLE), WIFI, Zigbee, Near Field Communication (NFC), 3GPP Device to Device Communication (D2D) and 3GPP Machine to Machine Communication (M2M).

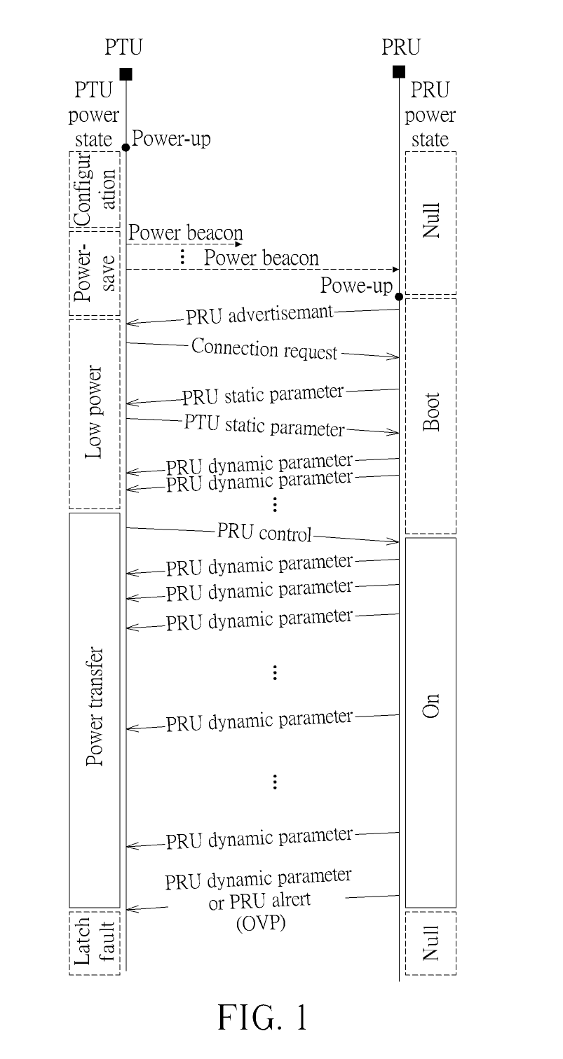

Besides, the second PRU may be detected by the PTU with that the second PRU sends a third message through the second type communication interface to the PTU (i.e. the second PRU cross connects to the PTU). The purpose of the third message is to notice the PTU that there is a newly coming PRU. For example, the third message is the “BLE Advertisement” of FIG. 1.

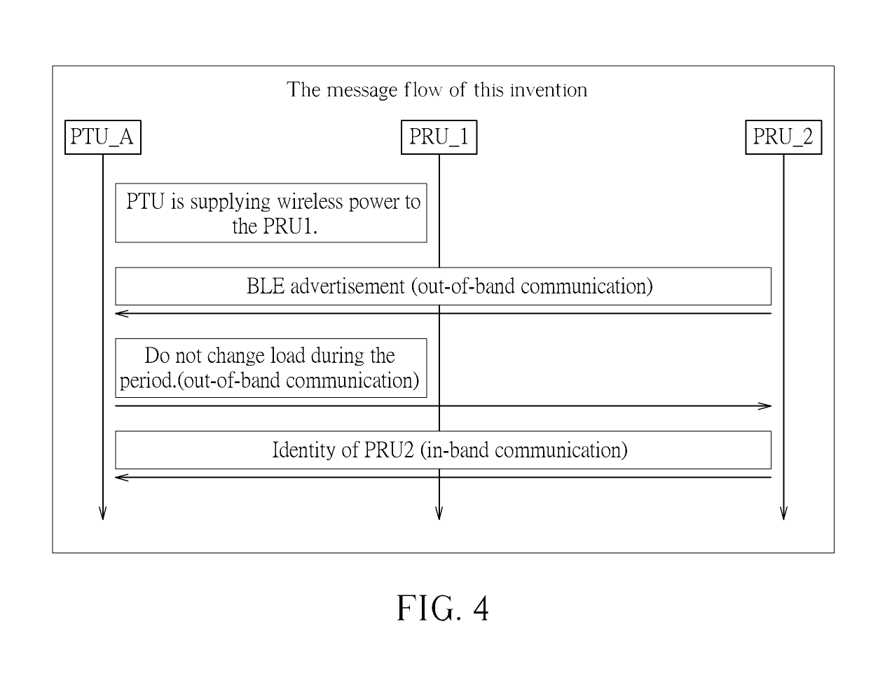

In detail, please refer to FIG. 4 for a message flow of the wireless power connection operation. In FIG. 4, the PTU_A is supplying wireless power to the PRU_1. The PRU_2 sends “BLE Advertisement” message to the PTU_A via the out-of-band communication interface, to indicate PTU_A that PRU_2 is placed around. After the PTU_A receives “BLE Advertisement” message, the PTU_A determines that PRU_2 is detected and then send a message indicating that PRU_1 does not change its load condition during a period of time, to the PRU_1 via out-of-band communication interface. In addition, the PRU_2 sends its identity to the PTU_A via in-band communication interface, and thereby the PTU_A can successfully connect to the PRU_2 by the identity of the PRU_2, so as to provide wireless power to the PRU_2.

Since the PRU_1 being charged is required to avoid load change, the interference in the in-band communication interface form the PRU_1 is minimized. The identity message can be detected and decoded correctly by the PTU_A. Note that, the identity mentioned here can be the ID associated with the wireless power reception module. One example of the ID is the device ID defined in section 6.3.8 and section 6.3.9 in WPC Low Power specification v1.1.2, which includes Manufacture Code and (Basic/Extended) Device Identifier. In other embodiment, the identity mentioned here can be the ID associated with the other modules included in the PRU_2, such as the International Mobile Subscriber Identity (IMSI) or the Radio Network Temporary Identifier (RNTI) provided by cellular module or ID provided by BLE/NFC module. The association implies that the identity may not be equal to the ID. The ID may be encoded (e.g. scrambled, truncated) to be an identity. Or, the identity can also be a random number, generated randomly by the PRU_2.

Take an example based on the process 30. Considering a wireless charging pad which can supply wireless power to multiple mobile phones simultaneously, there exist two communication interfaces between the charging pad and mobile phones. One is bi-directional BLE communication interface and another is uni-directional in-band communication interface (i.e. load modulation, from mobile phone to charging pad). There is already a first smart phone placed on the charged pad. The charging pad is supplying wireless power to the first smart phone and is communicating with the first smart phone via the BLE communication interface. When the second smart phone comes close to the charging pad, it can detect the wireless power from the charging pad. The second smart phone then broadcasts a BLE advertisement and this advertisement can be received by the charging pad. After the charging pad receives this advertisement, it understands that there is a new smart phone waiting for charge. After waiting for 50 ms, the charging pad sends a BLE message to the first smart phone, to require the first smart phone not to change its load for 200 ms period which starts from a time 100 ms after it receives the BLE message. The first smart phone does not change it load for 200 ms from the time 100 ms after it receives the BLE message. Then the interference from the first smart phone over the in-band communication interface is minimized.

For the second smart phone, it waits for 200 ms after sending the BLE advertisement and then sends its identity to the charging pad via in-band communication interface. The identity is the (partial) ID of its BLE module, which can be used by the charging pad to avoid cross-connection problem. The charging pad builds up BLE connection only with the smart phone which has the same BLE ID as the ID received via the in-band communication.

If for some reason the charging pad does not detect the identity from the second smart phone, it waits for the next BLE advertisement and repeats the above steps. For the second smart phone side, if it does not receives further BLE message from the charging pad using the ID it transmitted, it will send the advertisement one more time.

The abovementioned steps of the process 30 including suggested steps may be realized by means of hardware, software, firmware, or an electronic system. Examples of hardware may include analog, digital and mixed circuits known as microcircuit, microchip, or silicon chip. Examples of the electronic system may include a system on chip (SOC), system in package (SiP), and a computer on module (COM).

To sum up, the present invention provides a method of wireless power connection. In detail, the PTU is allowed to negotiate with existing charging PRUs via the out-of-band communication interface to arrange a time slot for the newly coming PRU to deliver it identity in the in-band communication interface which is attached on the wireless power signal. Therefore, the newly coming PRU delivers its identity to the PTU through the in-band communication interface without interference.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of a wireless power connection for a power transmitting unit (PTU) in a wireless power system, comprising:
providing a wireless power to a first power receiving unit (PRU) of a wireless power system;
communicating with the first PRU via a fist communication interface and a second communication interface;
detecting the appearance of a second PRU; and
transmitting a first message through the second communication interface to the first PRU, wherein the first message is used for requiring that the first PRU does not generate any interference on the first communication interface.

2. The method of claim 1, wherein the first wireless communication interface is In-Band, which is realized by a modulation of wireless power signals of the wireless power base station, and the modulation is Load modulation and wherein the second wireless communication interface is Out-of-Band, which is realized by Bluetooth Low Energy (BLE), Near Field Communication (NFC), Zigbee, Device-to-Device (D2D) communication or Machine-to-Machine (M2M) communication defined by third generation partnership project.

3. The method of claim 1, wherein the detecting step comprises:
receiving a second message through the second communication interface from the second PRU; and
determining that the second PRU is detected.

4. The method of claim 1, wherein the interference includes adjustment of load condition.

5. The method of claim 1, wherein first message includes a starting time or a period to indicate that the first PRU does not generate any interference at the starting time or during the period.

6. The method of claim 1, further comprising:
receiving a third message through the first communication interface from the second PRU, wherein the third message includes an identity of the second PRU; and
connecting to the second PRU through the second communication interface with the identity received from the third message.

7. A method of a wireless power connection for a power receiving unit (PRU) in a wireless power system, comprising:
receiving a wireless power from a power transmitting unit (PTU) of a wireless power system;
communicating with the PTU via a fist communication interface and a second communication interface; and
receiving a first message through the second communication interface from the PTU, wherein the first message is used for requiring that the PRU does not generate any interference on the first communication interface.

8. The method of claim 7, wherein the first wireless communication interface is In-Band, which is realized by a modulation of wireless power signals of the wireless power base station, and the modulation is Load modulation and wherein the second wireless communication interface is Out-of-Band, which is realized by Bluetooth Low Energy(BLE), Near Field Communication(NFC), Zigbee, Device-to-Device (D2D) communication or Machine-to-Machine (M2M) communication defined by third generation partnership project.

9. The method of claim 7, wherein the interference includes adjustment of load condition.

10. The method of claim 7, wherein first message includes a starting time or a period to indicate that the PRU does not generate any interference at the starting time or during the period.
